(19) United States
(12) Patent Application Publication
(10) Pub. No.: US 2012/0118717 A1
(43) Pub. Date: May 17, 2012

(54) Actuator for a Rocker Switch

(75) Inventors: Eric James Hanson, Valparaiso, IN (US); Robert B. Riggs, Canton, MI (US)

(73) Assignee: CATERPILLAR, INC., Peoria, IL (US)

(21) Appl. No.: 12/947,387

(22) Filed: Nov. 16, 2010

(51) Int. Cl. H01H 23/00

(52) U.S. Cl. 200/5 A; 200/339

(57) ABSTRACT

A rocker switch may include a housing and an actuator pivotably mounted relative to the housing for movement between an initial position and an actuated position. The actuator may include an exterior face defining a first contact surface and a second contact surface, the first contact surface being substantially planar and disposed within a first contact plane, and the second contact surface being substantially planar and disposed within a second contact plane, wherein the second contact plane is spaced from and substantially parallel to the first contact plane. The contact surfaces are oriented to clearly indicate, by look and/or feel, whether the rocker switch is in a first position or a second position, thereby allowing a position of the switch to be readily discerned

### TECHNICAL FIELD

This disclosure relates generally to electrical switching apparatus, and more particularly to rocker switches.

### BACKGROUND

Rocker switches are generally known in the art for performing electrical switching operations, such as switching electrical circuits on and off or switching over from one electrical circuit to another. For example, U.S. Pat. No. 7,105,762 to Lee discloses a rocker switch that generally includes a housing with an actuator pivotably mounted relative to the housing. The actuator interacts with one or more movable contacts disposed inside the housing to selectively place the contacts in to or out of engagement with associated stationary contacts. For example, when the actuator is moved to a first position, the actuator may disengage the movable contact(s) from the stationary contact(s), thereby turning the associated electrical circuit off. When the actuator is in a second position, it may engage the movable contact(s) with the stationary contact(s) to turn the electrical circuit on. In operation, an operator may manually engage an exterior surface of the actuator to move it to a selected one of the two positions. The actuator pivots or rocks between the two positions to break or connect the circuit, as desired.

Some conventional rocker switches may include various indicia for communicating to the operator a position of the switch. For example, known rocker switches may have actuators that carry the words “ON” and “OFF”, or symbols corresponding to those positions. Other switches may provide an indicator light that illuminates when the switch is in the “ON” position. Additionally, other switches are known that use a tactile feature to indicate position. The exterior surface of the actuator may be formed with sets of projections, such as Braille bumps, for identifying the ends of the actuator associated with the “ON” and “OFF” positions.

### SUMMARY OF THE DISCLOSURE

According to certain aspects of this disclosure, a rocker switch may include a housing and an actuator pivotably mounted relative to the housing for movement between an initial position and an actuated position. The actuator may include an exterior face defining a first contact surface and a second contact surface, the first contact surface being substantially planar and disposed within a first contact plane, and the second contact surface being substantially planar and disposed within a second contact plane, wherein the second contact plane is spaced from and substantially parallel to the first contact plane.

According to additional aspects of this disclosure that may be combined with any of these aspects, a rocker switch may be provided for use with a substantially vertical support surface. The rocker switch may include a housing adapted for coupling to the support surface and an actuator pivotably mounted relative to the housing for movement between an initial position and an actuated position. The actuator may include an exterior face defining an upper contact surface having an interior edge, a lower contact surface having an interior edge, and a transition surface disposed between the upper contact surface and lower contact surface, the transition surface extending from the upper contact surface interior edge to the lower contact surface interior edge. The upper contact surface may be substantially planar and disposed within an upper contact plane and the lower contact surface may be substantially planar and disposed within a lower contact plane. The lower contact plane may be spaced from and substantially parallel to the upper contact plane. The upper contact surface interior edge may be longitudinally spaced from the lower contact surface interior edge, and the lower contact surface may include an exterior edge defining a lip, wherein the lip is disposed at a lip angle with respect to the lower contact plane.

According to further aspects of this disclosure that may be combined with any of these aspects, an instrument panel may include a first array of three rocker switches and a second array of three rocker switches spaced from the first array of three rocker switches. Each rocker switch may include a housing, an actuator pivotably mounted relative to the housing for movement between an initial position and an actuated position, the actuator including, and an exterior face defining a first contact surface and a second contact surface. The first contact surface may be substantially planar and disposed within a first contact plane, and the second contact surface may be substantially planar and disposed within a second contact plane, wherein the second contact plane is spaced from and substantially parallel to the first contact plane.

In another aspect of the disclosure that may be combined with any of these aspects, the actuator further may include a transition surface extending between the first contact surface and the second contact surface.

In another aspect of the disclosure that may be combined with any of these aspects, the actuator further may include a pivot mechanism aligned with the transition surface along a reference plane extending substantially normal to the first and second contact planes.

In another aspect of the disclosure that may be combined with any of these aspects, the actuator further may include first and second lateral sidewalls depending from the exterior face and defining the pivot mechanism.

In another aspect of the disclosure that may be combined with any of these aspects, the first contact surface may include an interior edge, the second contact surface may include an interior edge, and the transition surface may extend from the first contact surface interior edge to the second contact surface interior edge.

In another aspect of the disclosure that may be combined with any of these aspects, the first contact surface interior edge may be longitudinally spaced from the second contact surface interior edge.

In another aspect of the disclosure that may be combined with any of these aspects, the rocker switch may be coupled to a support surface defining a support plane, the first and second contact planes may be disposed at a first angle with respect to the support plane when the actuator is in the initial position, and the first and second contact planes may be disposed at a second angle with respect to the support plane when the actuator is in the actuated position, wherein the second angle is less than the first angle.

In another aspect of the disclosure that may be combined with any of these aspects, the second contact surface may be positioned closer to the support surface than the first contact surface when the actuator is in the initial position.

In another aspect of the disclosure that may be combined with any of these aspects, the second contact surface may be positioned farther away from the support surface than the first contact surface when the actuator is in the actuated position.

In another aspect of the disclosure that may be combined with any of these aspects, the support surface may be substantially vertical, the first contact surface may comprise an upper contact surface, and the second contact surface may comprise a lower contact surface.

In another aspect of the disclosure that may be combined with any of these aspects, the second contact surface may include an exterior edge defining a lip, and the lip may be disposed at an angle with respect to the second contact plane.

In another aspect of the disclosure that may be combined with any of these aspects, in which each of the first and second contact surfaces may have a lateral width substantially equal to a width of an average thumb.

In another aspect of the disclosure that may be combined with any of these aspects, the first array of three rocker switches may include laterally aligned rocker switches, and the second array of three rocker switches may include laterally aligned rocker switches.

### BRIEF DESCRIPTION OF THE DRAWINGS

FIG. 1 is a side elevation view, in cross-section, of a rocker switch constructed according to the present disclosure.

FIG. 2 is an enlarged perspective view of an actuator from the rocker switch of FIG. 1.

FIG. 3A is an enlarged side elevation view of the actuator of FIG. 2 in a first position.

FIG. 3B is an enlarged side elevation view of the actuator of FIG. 2 in a second position.

FIG. 4 is a side elevation view of an instrument panel including clustered arrays of rocker switches.

FIG. 5 is an enlarged perspective view of three actuators provided in a clustered array of rocker switches from FIG. 4.

### DETAILED DESCRIPTION

Rocker switches are disclosed herein that efficiently and intuitively indicate the position of the switch. The rocker switches include an actuator having an exterior surface formed with tiered contact surfaces. The contact surfaces are oriented to clearly indicate, by look and/or feel, whether the rocker switch is in a first position or a second position. As such, the rocker switches require minimal viewing and attention from an operator to discern the switch's position, thereby reducing distraction of the operator from his or her primary task.

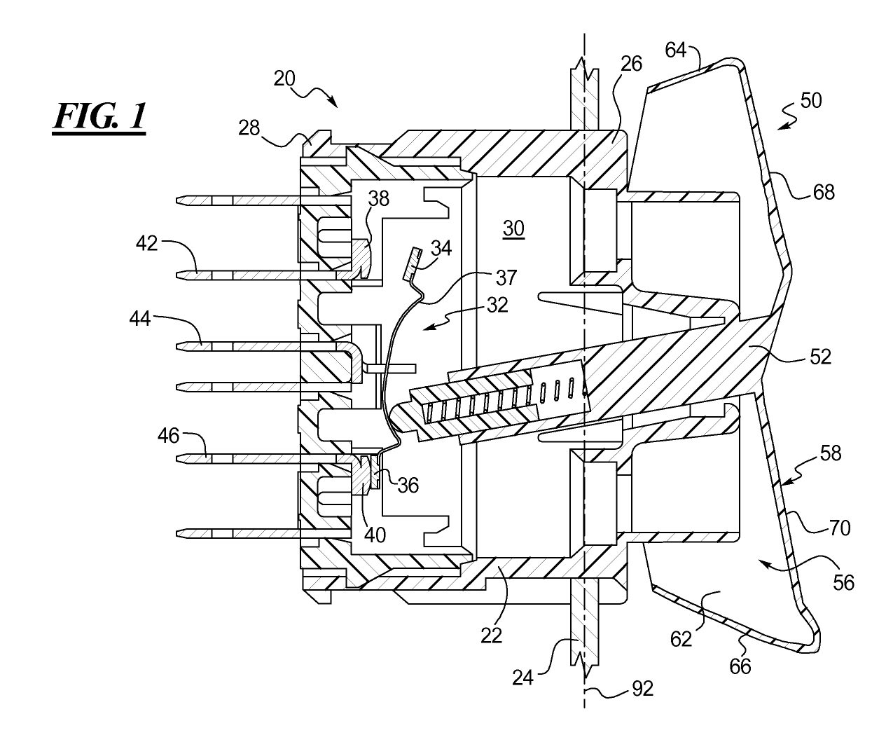

Referring to FIG. 1, a rocker switch 20 constructed according to the present disclosure includes a housing 22. The housing 22 may be mounted on a support surface 24, such as a wall, enclosure, or instrument panel. The support surface 24 may be oriented at any angle, including substantially vertically (as shown in FIG. 1) and horizontally (not shown). Additionally, the support surface 24 may have a fixed location, such as on a control panel mounted on a building, or a movable location, such as on an instrument panel mounted on a machine or vehicle. The housing 22 may include a proximal portion 26 that extends partially outwardly from the support surface 24 and a distal portion 28 that is recessed behind the support surface 24. As used herein, the term “proximal” indicates a location or position that is nearer to the operator of the rocker switch 20, while “distal” indicates a location or position that is farther from the operator of the rocker switch 20. The housing 22 may be formed of a non-conductive material, such as a heat-resistant plastic, and defines a cavity 30.

A conventional switching mechanism 32 is disposed in the cavity 30 near the housing distal portion 28 for conveying a switch signal. The exemplary switching mechanism 32 illustrated in FIG. 1 includes two movable contacts 34, 36 mounted on a contact support 37 and positioned to selectively engage associated stationary contacts 38, 40. The stationary contacts 38, 40 electrically communicate with terminals 42, 44, and 46 extending from the distal portion 28 of the housing 22. The terminals 42, 44, 46 electrically communicate with associated electrical circuits, so that the engagement of one of the movable contacts 34, 36 with the associated stationary contact 38, 40 will turn an associated electrical circuit on or off.

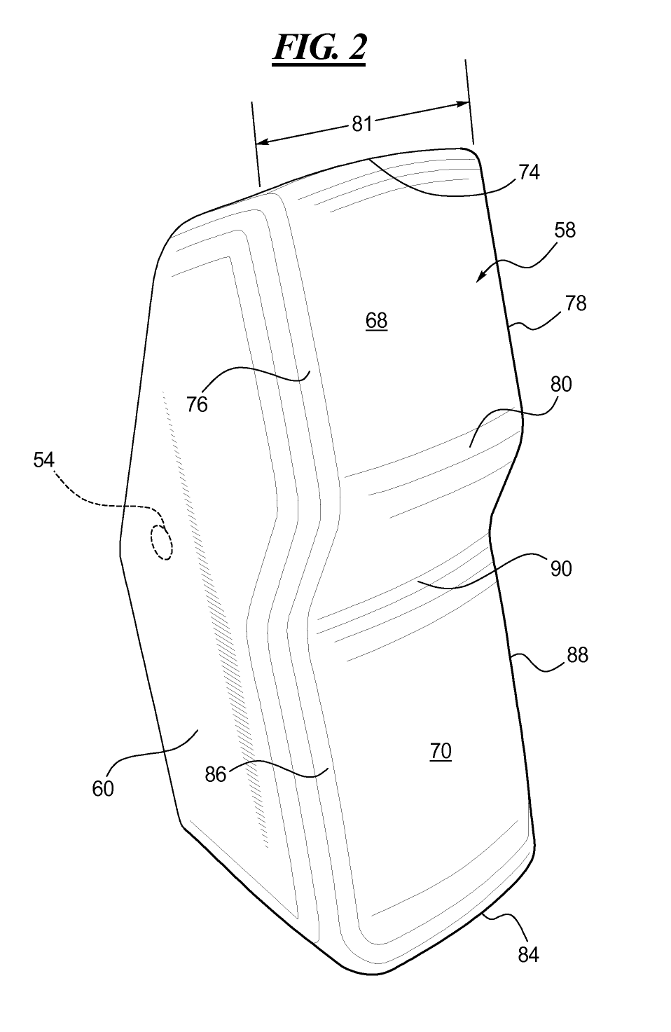

The rocker switch 20 further includes an actuator 50 pivotably coupled to the housing 22 and operably coupled to the movable contacts 34, 36. In the illustrated embodiment, the actuator 50 includes a center post 52 configured to engage the contact support 37. Pivotal movement of the actuator 50 relative to the housing 22 will alter the orientation of the contact support 37, thereby engaging one of the movable contacts 34, 36 with the associated stationary contact 38, 40. As best shown in FIG. 2, the actuator 50 includes a pivot mechanism, such as two recesses 54, sized to pivotably receive a pivot posts (not shown) coupled to the housing 22. Any conventional pivot means may be used to pivotably mount the actuator 50 relative to the housing. The pivot mechanism permits the actuator 50 to pivot between at least first and second positions, as described in greater detail below.

The actuator 50 further includes a cover 56 extending over the center post 52 and providing an operator interface. The cover 56 includes an exterior face 58, side walls 60, 62, a top wall 64, and a bottom wall 66. As best shown in FIGS. 1 and 2, the side walls 60, 62, top wall 64, and bottom wall 66 are joined together and extend distally from a periphery of the exterior face 58. A recess 54 may be formed in an interior surface of each side wall 60, 62 to provide the pivot mechanism.

The exterior face 58 provides surfaces that are engageable by the operator to move the actuator between first and second positions. More specifically, the exterior face 58 includes a first contact surface 68 and a second contact surface 70. The first contact surface 68 is substantially planar and is disposed within a first contact plane 72. The first contact surface 68 has a generally square or rectangular shape bounded by an exterior edge 74, lateral edges 76, 78, and an interior edge 80. In the illustrated embodiment, the first contact surface 68 spans substantially an entire lateral width 81 of the actuator 50. The second contact surface 70 is also substantially planar and is disposed within a second contact plane 82. The second contact surface 70 further has a generally square or rectangular shape bounded by an exterior edge 84, lateral edges 86, 88, and an interior edge 90. The second contact surface 70 may also span substantially the entire lateral width 81 of the actuator 50. The lateral width 81 may be substantially equal to a width of an average thumb to provide ample space for engagement by an operator.

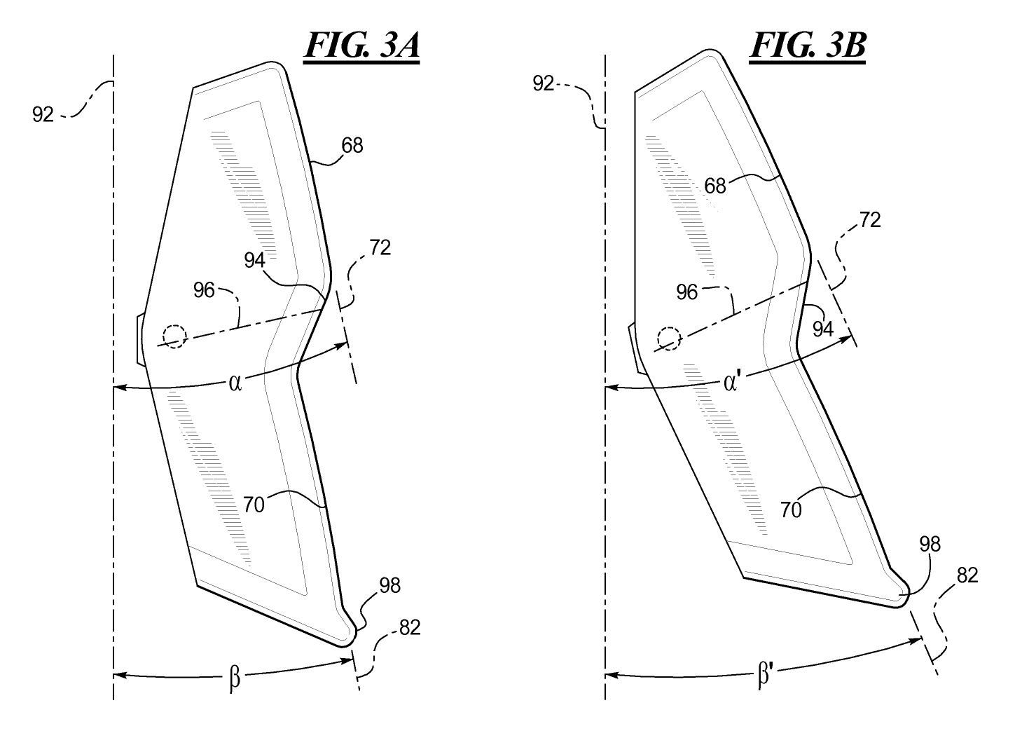

The first and second contact planes 72, 82 are positioned and oriented to form tiers on the exterior face 58 which clearly communicate to the operator a position of the actuator 50 and associated rocker switch function. FIG. 3A shows the actuator 50 in the first or initial position. The first contact plane 72, generally indicating the orientation of the first contact surface 68, extends at a first angle α relative to a support plane 92 defined by the support surface 24 (FIGS. 1, 3A, 3B). The second contact plane 82, generally indicating the orientation of the second contact surface 70, extends at a second angle β relative to the support plane 92. The first initial angle α and second initial angle β are substantially equal, and the first and second contact planes 72, 82 are therefore substantially parallel. Additionally, the first and second contact planes 72, 82 are separate planes that are spaced from one another, and therefore the first and second contact surfaces 68, 70 residing within the planes are spaced, thereby to present to the operator a tiered exterior face 58. When the actuator 50 is in the initial position shown in FIG. 3A, the second contact surface 70 is positioned closer to the support surface 24 than the first contact surface 68.

The actuator 50 may be moved to a second or actuated position as shown in FIG. 3B. As illustrated, the actuator 50 has rotated counter-clockwise so that the first contact plane 72 is now at a first actuated angle α′ and the second contact plane 82 is at a second actuated angle β′ relative to the support plane 92. The first and second actuated angles α′ and β′ are substantially equal and are greater than the first and second initial angles α and β. Accordingly, when the actuator 50 is in the actuated position shown in FIG. 3B, the second contact surface 70 is positioned farther away from the support surface 24 than the first contact surface 68.

The exterior face 58 of the actuator 50 may further include a transition surface 94 extending between the first and second contact surfaces 68, 70. As best shown in FIG. 2, the transition surface 94 extends from the interior edge 80 of the first contact surface 68 to the interior edge 90 of the second contact surface. The interior edges 80, 90 are longitudinally spaced from each other, so the transition surface 94 generally forms obtuse angles with the adjacent first and second contact surfaces 68, 70. The recesses 54 are positioned on the side walls 60, 62 such that they are aligned with a reference plane 96 extending substantially normal to the first and second contact planes 68, 70.

The lower contact surface 70 may further include a lip 98 to further communicate rocker switch function and to facilitate engagement by the operator. The lip 98 is positioned along the exterior edge 84 and projects proximally from the lower contact surface 70. Thus, when the actuator 50 is in the actuated position (FIG. 3B), the lip 98 defines the farthest proximal extent of the actuator 50 located closest to the operator. The lip 98 provides an easily recognizable feature that may clearly indicate the position of the actuator 50. Additionally, the lip 98 provides a curved surface that permits the operator to more reliably engage the actuator 50 when returning it to the initial position.

### INDUSTRIAL APPLICABILITY

The actuator 50 having the exterior face 58 formed as described above clearly indicates to the operator the state of the rocker switch 20. The tiered, parallel contact surfaces 68, 70 provide a visual indication as to the position of the actuator 50, and also more readily permit an operator to ascertain switch position by touch (i.e., without visual inspection). The rocker switch 20 may be positioned so that, when the actuator is in the initial position, the first contact surface 68 is positioned more proximally (i.e., closer to the operator) than the second contact surface 70. When oriented vertically, the first contact surface 68 may be an upper contact surface and the second contact surface may be a lower contact surface. The upper contact surface may be associated with the “ON” function of the switch, thereby presenting this option more prominently to the operator when the switch is in the initial position. When in the actuated position, the lip 98 of the lower contact surface 70 is positioned more proximal than the upper contact surface 68, thereby presenting the “OFF” function more prominently to the user. The relative positions of the first and second contact surfaces 68, 70 provide an actuator 50 that functions more intuitively, thereby reducing the amount of attention from the operator needed to operate the switch.

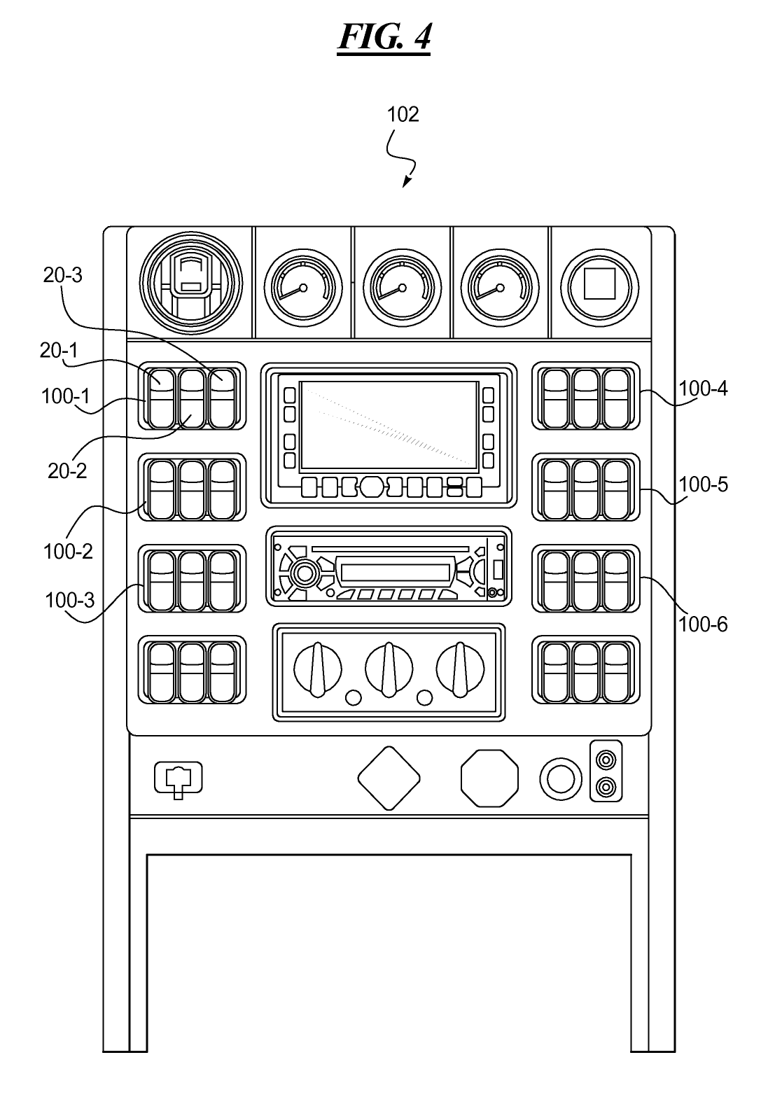

While the rocker switch 20 provides certain benefits when used individually, additional benefits may be recognized when groups or clusters of rocker switches having identical actuators 50 are provided. FIG. 4 illustrates a control panel 102 for a vehicle. The control panel includes six arrays 100-1, 100-2, 100-3, 100-4, 100-5, and 100-6, each including three rocker switches 20. The arrays 100-1, 100-2, 100-3, 100-4, 100-5, and 100-6 are spaced from each other to provide well-defined clusters of switches. Each array 100-1, 100-2, 100-3, 100-4, 100-5, and 100-6 may include switches for similar or related functions. For example, array 100-1 may include switches 20-1, 20-2, and 20-3 all related to windshield wiper functions, such as front wiper operation, rear wiper operation, and wiper fluid discharge. The distinct spacing of the arrays 100-1, 100-2, 100-3, 100-4, 100-5, and 100-6 allows the operator to become familiar with the different array locations and associate the arrays with their particular functions.

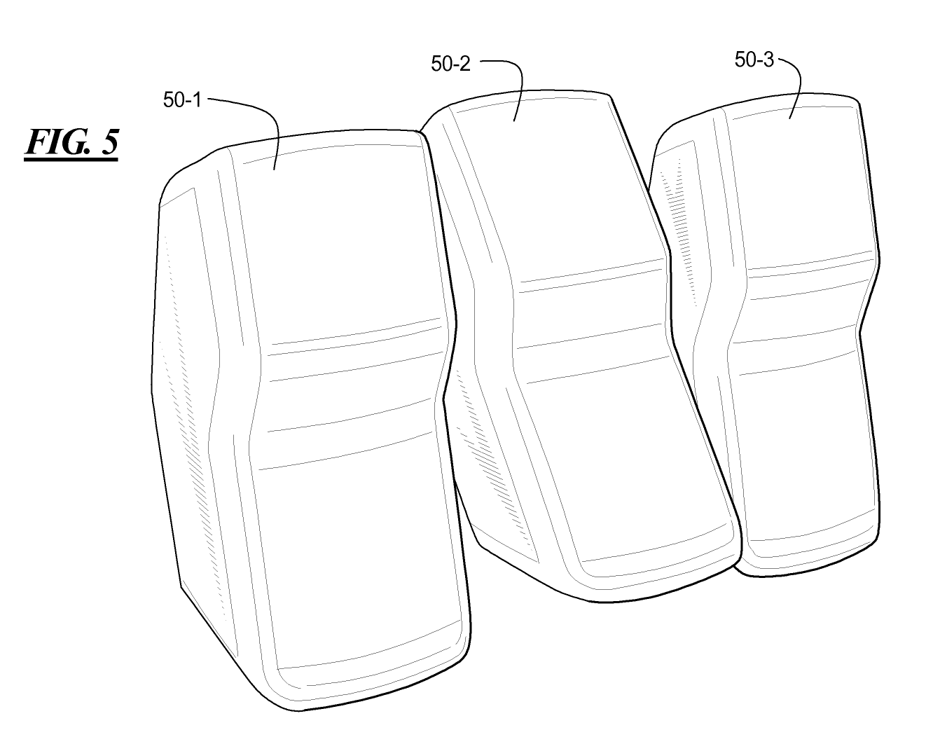

Additionally, the provision of sets of aligned rocker switches adjacent one another improves the ability of the operator to identify the position of each actuator 50. FIG. 5 illustrates three actuators 50-1, 50-2, and 50-3 from the array 100-1 of three rocker switches 20-1, 20-2, and 20-3. Actuators 50-1 and 50-3 are in the initial position, while actuator 50-2 is in the actuated position. The juxtaposition of actuators 50-1, 50-2, and 50-3 permits the operator to quickly and accurately identify the position of each switch, either visually or by feel, thereby minimizing distractions during operation of the vehicle.

What is claimed is:

1. A rocker switch comprising:
a housing;
an actuator pivotably mounted relative to the housing for movement between an initial position and an actuated position, the actuator including:
an exterior face defining a first contact surface and a second contact surface;
the first contact surface being substantially planar and disposed within a first contact plane; and
the second contact surface being substantially planar and disposed within a second contact plane, wherein the second contact plane is spaced from and substantially parallel to the first contact plane.

2. The rocker switch of claim 1, in which the actuator further comprises a transition surface extending between the first contact surface and the second contact surface.

3. The rocker switch of claim 2, in which the actuator further comprises a pivot mechanism aligned with the transition surface along a reference plane extending substantially normal to the first and second contact planes.

4. The rocker switch of claim 3, in which the actuator further comprises first and second lateral sidewalls depending from the exterior face and defining the pivot mechanism.

5. The rocker switch of claim 2, in which the first contact surface includes an interior edge, the second contact surface includes an interior edge, and the transition surface extends from the first contact surface interior edge to the second contact surface interior edge.

6. The rocker switch of claim 5, in which the first contact surface interior edge is longitudinally spaced from the second contact surface interior edge.

7. The rocker switch of claim 1, in which the rocker switch is coupled to a support surface defining a support plane, and in which the first and second contact planes are disposed at a first angle with respect to the support plane when the actuator is in the initial position, and the first and second contact planes are disposed at a second angle with respect to the support plane when the actuator is in the actuated position, wherein the second angle is less than the first angle.

8. The rocker switch of claim 7, in which the second contact surface is positioned closer to the support surface than the first contact surface when the actuator is in the initial position.

9. The rocker switch of claim 8, in which the second contact surface is positioned farther away from the support surface than the first contact surface when the actuator is in the actuated position.

10. The rocker switch of claim 9, in which the support surface is substantially vertical, and in which the first contact surface comprises an upper contact surface and the second contact surface comprises a lower contact surface.

11. The rocker switch of claim 1, in which the second contact surface includes an exterior edge defining a lip, and in which the lip is disposed at an angle with respect to the second contact plane.

12. The rocker switch of claim 1, in which each of the first and second contact surfaces has a lateral width substantially equal to a width of an average thumb.

13. A rocker switch for use with a substantially vertical support surface, the rocker switch comprising:
a housing adapted for coupling to the support surface;
an actuator pivotably mounted relative to the housing for movement between an initial position and an actuated position, the actuator including:
an exterior face defining an upper contact surface having an interior edge, a lower contact surface having an interior edge, and a transition surface disposed between the upper contact surface and lower contact surface, the transition surface extending from the upper contact surface interior edge to the lower contact surface interior edge;
the upper contact surface being substantially planar and disposed within an upper contact plane;
the lower contact surface being substantially planar and disposed within a lower contact plane;
the lower contact plane being spaced from and substantially parallel to the upper contact plane;
the upper contact surface interior edge being longitudinally spaced from the lower contact surface interior edge; and
the lower contact surface including an exterior edge defining a lip, wherein the lip is disposed at a lip angle with respect to the lower contact plane.

14. The rocker switch of claim 13, in which the actuator further comprises a pivot mechanism aligned with the transition surface along a reference plane extending substantially normal to the upper and lower contact planes.

15. The rocker switch of claim 13, in which the upper and lower contact planes are disposed at a first angle with respect to a support plane when the actuator is in the initial position, and the upper and lower contact planes are disposed at a second angle with respect to the support plane when the actuator is in the actuated position, wherein the second angle is less than the first angle.

16. An instrument panel comprising:
a first array of three rocker switches;
a second array of three rocker switches spaced from the first array of three rocker switches;
wherein each rocker switch includes:
a housing;
an actuator pivotably mounted relative to the housing for movement between an initial position and an actuated position, the actuator including:
an exterior face defining a first contact surface and a second contact surface;
the first contact surface being substantially planar and disposed within a first contact plane; and
the second contact surface being substantially planar and disposed within a second contact plane, wherein the second contact plane is spaced from and substantially parallel to the first contact plane.

17. The instrument panel of claim 16, in which the first array of three rocker switches comprises laterally aligned rocker switches, and in which the second array of three rocker switches comprises laterally aligned rocker switches.

18. The actuator of claim 16, further comprising a transition surface extending between the first contact surface and the second contact surface.

19. The rocker switch of claim 16, in which the rocker switch is coupled to a support surface defining a support plane, and in which the first and second contact planes are disposed at a first angle with respect to the support plane when the actuator is in the initial position, and the first and second contact planes are disposed at a second angle with respect to the support plane when the actuator is in the actuated position, wherein the second angle is less than the first angle.

20. The rocker switch of claim 16, in which the second contact surface includes an exterior edge defining a lip, and in which the lip is disposed at an angle with respect to the second contact plane.
